(19) United States
(12) Patent Application Publication
(10) Pub. No.: US 2004/0190225 A1
(43) Pub. Date: Sep. 30, 2004

(54) Silicon-containing compound, sintered body of silicon-containing compound, and producing method thereof, and completely solid type capacitor element using same

(75) Inventors: Akiji Higuchi, Kyoto-City (JP); Ayako Maruta, Kyoto-City (JP); Kouichi Yamaguchi, Kyoto-City (JP); Hiroshi Tsushima, Neyagawa-City (JP); Takeshi Oka, Neyagawa-City (JP); Emi Watanabe, Neyagawa-City (JP); Masashi Ohata, Neyagawa-City (JP)

Correspondence Address: 601 PENNSYLVANIA AVENUE, N.W., SUITE 900, SOUTH BUILDING, WASHINGTON, DC, 20004, US

(73) Assignee: Nippon Paint Co., Ltd.

(21) Appl. No.: 10/400,534

(22) Filed: Mar. 28, 2003

(51) Int. Cl. H01G 9/02

(52) U.S. Cl. 361/525

(57) ABSTRACT

A silicon-containing compound of solid state including neither a compound capable of dissociating into positive and negative ions nor a liquid electrolyte and a gel electrolyte, and exhibiting a dielectric relaxation phenomenon in the frequency range of 100 Hz to 1 MHz, and preferably a sintered body of silicon-containing compound obtained by sintering at least one of the silicon-containing compounds selected from polysilanes and silicones which are dissolvable to organic solvents.

### BACKGROUND OF THE INVENTION

1. Field of the Invention

The present invention relates to a silicon-containing compound, a sintered body of silicon-containing compound, and a producing method thereof, and a completely solid type capacitor element using the same, and more specifically to a silicon-containing compound, a sintered body of silicon-containing compound, and a producing method thereof, and a completely solid type capacitor element using the same which are desirably used, in particular, for various kinds of members of electronic device, power supply, auxiliary power supply and so on.

2. Related Art

Silicon compounds such as polysilanes having a basic structure of Si—Si bond are often used in photoresists and color filters because of their photodegradability. For example, Japanese Patent Laid-Open No. 2001-281436 discloses that by employing a color pattern forming method which comprises the steps of: selectively exposing a thin film made of a photosensitive resin composition containing a polysilane of a specific structure and a cyclic silane compound of a specific structure with light, thereby forming a latent image of the color pattern in the exposed portion, and coloring said exposed portion in which the latent image of the color pattern is formed with a coloring liquid including a dye or a pigment, it is possible to reduce the time required for producing the color filter. Also Japanese Patent Laid-Open No. 2001-281421 discloses an example wherein a polysilane is used for a light reflective plate equipped with a diffusion plate.

Furthermore, “Synth. Met., 94, 299 (1998)” suggests that by reacting a compound having high electron acceptability such as iodine and antimony fluoride on a polysilane, electron conductivity appears.

Furthermore, as a method for completely solidifying capacitor elements such as battery and capacitor, “Optical/Electronic Functional Organic Material Handbook (1995)” published from Asakura Shoten teaches a method wherein as an electrolyte, a polymeric material called a solid electrolyte in which an alkali metal salt such as lithium sulfate and lithium perchlorate is dispersed in a polar polymer such as polyethylene oxide.

It is suggested that use of such a polymeric solid electrolyte enables a lithium battery of completely solid type to be produced.

However, since polysilane conductive materials wherein compounds having high electron acceptability such as iodide and antimony fluoride are made to act are unstable and difficult to handle in the air, it was impossible to utilize such polysilane conductive materials for industrially useful electronic devices as represented by energy elements, sensors and transistors.

Moreover, since polymeric solid electrolytes have lower ion conductivity compared to liquid and gel electrolytes, batteries using polymeric solid electrolytes could not satisfy the specification for batteries of practical use. Additionally, in principal, the ion conducting mechanism of polymeric solid electrolyte strongly depends on the environmental temperature under which the electrolyte is used, so that there was a problem that the operational temperature range of completely solid type capacitor element using a polymeric solid electrolyte is narrow.

### SUMMARY OF THE INVENTION

The present invention was devised for solving the above-mentioned problems, and it is an object of the invention to provide a silicon-containing compound and a sintered body of silicon-containing compound which are stable in the air and capable of providing a completely solid type capacitor element having a wide operational temperature range and high reliability, as well as a producing method thereof, and a completely solid type capacitor element using the same.

The inventors of the present invention made special efforts to solve the above problems. As a result of the research, it was found that some of silicon-containing compounds or sintered bodies of silicon-containing compound act as an electric conductor which is stable in the air, and found a method of producing the sintered bodies of silicon-containing compound. It was also found that a completely solid type capacitor element can be produced using these silicon-containing compounds or sintered bodies of silicon-containing compound, to finally accomplish the present invention.

To be more specific, a silicon-containing compound of solid state according to the present invention is a silicon-containing compound characterized by including neither a compound capable of dissociating into positive and negative ions nor a liquid electrolyte and a gel electrolyte, and exhibiting a dielectric relaxation phenomenon in the frequency range of 100 Hz to 1 MHz.

By using the above silicon-containing compound, it becomes possible to produce a completely solid type capacitor element according to the present invention which has a wide operational temperature range and high reliability, as well as to produce sensors and energy converting elements.

A sintered body of silicon-containing compound of solid state according to the limited aspect of the present invention is characterized by including neither a compound capable of dissociating into positive and negative ions nor a liquid electrolyte and a gel electrolyte, and exhibiting a dielectric relaxation phenomenon in the frequency range of 100 Hz to 1 MHz.

By using the above sintered body of silicon-containing compound, it becomes possible to produce a completely solid type capacitor element according to the present invention which has a wide operational temperature range and high reliability, as well as to produce sensors and energy converting elements.

A sintered body of silicon-containing compound according to the limited aspect of the present invention is the sintered body of silicon-containing compound of the present invention, wherein the silicon-containing compound contains at least either one of silicon-containing compounds selected from a polysilane which is dissolvable to organic solvents, and a silicone having a chemical structure represented by the following general formula (1):

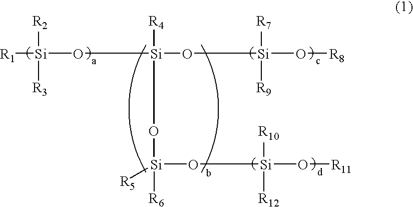

(wherein R₁ to R₁₂ which may be the same or different, represent a group selected from the group consisting of aliphatic hydrocarbon groups having 1 to 10 carbon(s) which may be substituted by a halogen or glycidyloxy group, aromatic hydrocarbon groups having 6 to 12 carbons, and alkoxy groups having 1 to 8 carbon(s); and a, b, c and d each represent an integer including 0 and satisfy the relation a+b+c+d≧1.)

By using the above sintered body of silicon-containing compound, it becomes possible to produce a completely solid type capacitor element according to the present invention which has a wide operational temperature range and high reliability, as well as to produce sensors and energy converting elements.

A sintered body of silicon-containing compound according to the limited aspect of the present invention is the sintered body of silicon-containing compound of the present invention, wherein the silicon-containing compound is a mixture containing a silicon compound and at least either one compound of a peroxide and a benzophenone derivative having a benzophenone backbone represented by the following formula (2):

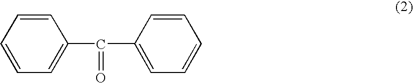

By using the above sintered body of silicon-containing compound, it becomes possible to produce a completely solid type capacitor element according to the present invention which has a wide operational temperature range and high reliability, as well as to produce sensors and energy converting elements.

A sintered body of silicon-containing compound according to the limited aspect of the present invention is the sintered body of silicon-containing compound according to the present invention, wherein the peroxide is a peroxide having at least one bond represented by —C(—O)—O—O— in its molecular structure.

A sintered body of silicon-containing compound according to the limited aspect of the present invention is the sintered body of silicon-containing compound according to the present invention, wherein the sintered body of silicon-containing compound has a Si—OH bond.

The Si—OH bond in the sintered body of silicon-containing compound can be confirmed by measurement of infrared absorption spectrum. The absorption band based on the Si—OH is usually observed around 955 cm⁻¹.

A sintered body of silicon-containing compound according to the limited aspect of the present invention is the sintered body of silicon-containing compound according to the present inventions which is obtained by sintering the silicon-containing compound at a temperature of not less than 400° C.

By using the above sintered body of silicon-containing compounds, it becomes possible to produce a completely solid type capacitor element according to the present invention which has a wide operational temperature range and high reliability, as well as to produce sensors and energy converting elements.

A completely solid type capacitor element according to the present invention is characterized by having a structure in which the silicon-containing compound according to the present invention is sandwiched between a pair of electrodes.

A completely solid type capacitor element according to the limited aspect of the present invention is characterized by having a structure in which the sintered body of silicon-containing compound according to the present invention is sandwiched between a pair of electrodes.

The above completely solid type capacitor elements can be used as a capacitor element having a wide operational temperature range and high reliability.

A completely solid type capacitor element according to the limited aspect of the present invention is the completely solid type capacitor element according to the present invention, wherein at least one of the pair of electrodes is formed of a chrome compound.

A completely solid type capacitor element according to the limited aspect of the present invention is the completely solid type capacitor element according to the present invention, wherein the chrome compound is formed of metal chrome by a heat treatment at the time of sintering the silicon-containing compound.

A completely solid type capacitor element according to the limited aspect of the present invention is the completely solid type capacitor element according to the present invention, wherein the pair of electrodes, the silicon-containing compound and the sintered body of silicon-containing compound are thin films in shape.

The above completely solid type capacitor elements can be used as a capacitor element of small size, light weight and low profile, having a wide operational temperature range and high reliability, so that miniaturization and weight saving of various electronic devices can be realized.

A method for producing a sintered body of silicon-containing compound according to the present invention is a method for producing a sintered body of silicon-containing compound including neither a compound capable of dissociating into positive and negative ions nor a liquid electrolyte and a gel electrolyte, and exhibiting a dielectric relaxation phenomenon in the frequency range of 100 Hz to 1 MHz, wherein the temperature at which the silicon-containing compound is sintered is not less than 200° C.

A method for producing a sintered body of silicon-containing compound according to the limited aspect of the present invention is the method for producing a sintered body of silicon-containing compound according to the limited aspect of the present invention 13, wherein the sintering temperature is not less than 400° C.

According to the above producing method, it is possible to produce a sintered body of silicon-containing compound which can be used in the present invention.

The term “silicon-containing compound of solid state” as used in the present invention refers to a solid containing a silicon-containing compound. The term “sintered body of silicon-containing compound of solid state” refers to a solid which is obtained by applying heat on a solid or liquid or gel silicon-containing compound containing a silicon compound.

As the silicon-containing compound, those including at least either one of a polysilane which is dissolvable to organic solvents and a silicone compound are recited. Preferably, those including both of a polysilane and a silicon compound are recited.

Next, polysilanes and silicone compounds will be explained.

<Polysilanes>

The polysilane used in the present invention is not particularly limited insofar as it is a linear, cyclic or branched silane compound having a Si—Si bond. The compounds that are generally called polysiline are also included therein.

Herein, “polysilane” is at least one kind of polymer selected from the group consisting of:

linear polysilanes and cyclic polysilanes whose main base structure in the chemical structure is represented by the general formula:

(R¹₂Si)ₘ (3)

(wherein R¹ which may be the same or different, represents a hydrogen atom, an alkyl group, an alkenyl group, an arylalkyl group, an aryl group, an alkoxyl group, a hydroxyl group, a hydroxyl-containing phenyl group, an amino group or a silyl group; and m represents 2 to 10000);

silicon network polymers having a main base structure represented by the general formula:

(R²Si)ₙ (4)

(wherein R²which may be the same or different, represents a hydrogen atom, an alkyl group, an alkenyl group, an arylalkyl group, an aryl group, an alkoxyl group, a hydroxyl group, a hydroxyl-containing phenyl group, an amino group or a silyl group; and n represents 4 to 10000); and

silicon network polymers having a main base structure represented by the general formula:

(R³₂Si)ₓ(R³Si)_{y}Si_{z} (5)

(wherein R³ represents a hydrogen atom, an alkyl group, an alkenyl group, an arylalkyl group, an aryl group, an alkoxyl group, a hydroxyl group, a hydroxyl-containing phenyl group, an amino group or a silyl group; all of R³s may be the same or two or more R³s may be different from each other; the sum of x, y and z is in the range of 5 to 10000).

In the polysilanes represented by the above general formulae (3), (4) and (5), as an alkyl moiety of the alkyl group and the arylalkyl group and an alkyl moiety of the alkoxyl group include linear, cyclic or branched aliphatic hydrocarbon groups having 1 to 14 carbon(s), preferably having 1 to 10 carbon(s), and more preferably having 1 to 6 carbon(s) can be recited. As the alkenyl group, univalent linear, cyclic or branched aliphatic hydrocarbon groups having at least one carbon-carbon double bond and having 1 to 14 carbon(s), preferably 1 to 10 carbon(s), and more preferably 1 to 6 carbon(s) can be recited. As the aryl group and an aryl moiety of the arylalkyl group, aromatic hydrocarbons which may have at least one substituent can be recited, and preferably a phenyl group or naphthyl group which may have at least one substituent can be recited. The substituent in the aryl group and an aryl moiety of the arylalkyl group is preferably, but not particularly limited to, at least one kind selected from the group consisting of an alkyl group, an alkoxyl group, a hydroxyl group and an amino group.

The polysilane used in the present invention may have at least one hydroxyl group directly bound to a Si atom (silanol group). The polysilane used in the present invention may have an average of one or more hydroxyl group directly bound to a Si atom per one molecule. The containing ratio of such a hydroxyl group is usually about 0.01 to 3 in average, preferably about 0.1 to 2.5 in average, more preferably about 0.2 to 2 in average and most preferably about 0.3 to 1.5 in average, per one si atom.

For introducing a hydroxyl group into a polysilane, conventional known methods can be used. It can be easily achieved by adding water at the end of condensation polymerization reaction, for example, in the method of condensation-polymerizing halosilanes by dehalogenation.

Also, as the polysilane, a silicone network polymer having a network structure is preferably used.

Also, as the polysilane, network polysilanes as recited in Japanese Patent Laid-Open No. 2001-48987 may be used. That is, it is possible to use network polysilanes that are formed by acting Mg or a Mg alloy on trihalosilane in an aprotic solvent in the presence of a Li salt and a halogenated metal.

As the polysilane used in the present invention, those having a weight average molecular weight of not less than 1000. If the weight average molecular weight is less than 1000, film properties such as chemical resistance and heat resistance would be insufficient. The weight average molecular weight is preferably in the range of 1000 to 10000, and more preferably in the range of 1000 to 20000.

<Silicone compounds>

As the silicone compound used in the present invention, those represented by the formula:

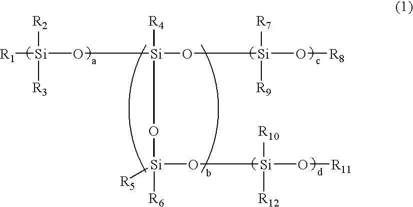

(wherein R₁ to R₁₂ which may be the same or different, represent a group selected from the group consisting of aliphatic hydrocarbon groups having 1 to 10 carbon(s) which may be substituted by a halogen or glycidyloxy group, aromatic hydrocarbon groups having 6 to 12 carbons, and alkoxy groups having 1 to 8 carbon(s); and a, b, c and d each represent an integer including 0 and satisfy the relation a+b+c+d≧1) can be recited.

Specific examples of the aliphatic hydrocarbon group possessed by the silicone compounds include chain groups such as methyl group, propyl group, butyl group, hexyl group, octyl group, decyl group, trifluoropropyl group and glycidyloxypropyl group, and alicyclic groups such as cyclohexyl group and methylcyclohexyl group. Specific examples of the aromatic hydrocarbon group include phenyl group, p-tolyl group and biphenyl group. Specific examples of the alkoxy group include methoxy group, ethoxy group, phenoxy group, octyloxy group and ter-butoxy group.

The kinds of above R₁ to R₁₂ and values of a, b, c and d are not especially critical, but any kinds and values are applicable insofar as compatibility with the polysilane and the organic solvent as well as transparency of the film are achieved. From the view point of the compatibility, the silicone compound preferably has the same group as the hydrocarbon group possessed by the polysilane in use. For example, in the case where a phenylmethyl-based polysilane is used, it is preferred to use the same phenylmethyl-based silicone compound or a diphenyl-based silicone compound. In addition, a silicone compound having two or more alkoxy groups in one molecule such that at least two of R₁ to R₁₂ are alkoxy groups having 1 to 8 carbon(s) can be used as a crosslinking agent. As such, methylphenylmethoxy silicone, phenylmethoxy silicone and the like containing 15 to 35% by weight of alkoxy groups can be recited.

The ratio of the polysilane and the silicone compound in the silicon-containing compound is preferably 1:99 to 99:1 (polysilane:silicone compound) by weight.

The silicon-containing compound may contain at least either one of a peroxide and a benzophenone derivative having a benzophenone backbone represented by the following formula (2) as a subsidiary component other than the silicon compound. In this case, the blending ratio of the silicon compound and the peroxide or the benzophenone derivative may be appropriately set, and as the peroxide, any compounds having at least one bond of —C (═O)—O—O— in the molecular structure can be used. As the solvent, a variety of organic solvents can be used.

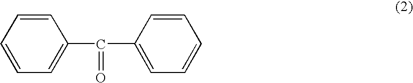

The content of the peroxide in the silicon-containing compound is preferably in the range of 1 to 49% by weight. The content of the benzophenone derivative is preferably in the range of 1 to 49% by weight.

The sintered body of silicon-containing compound in the present invention can be obtained by applying heat on the above-mentioned silicon-containing compound. The thin film of the sintered body of silicon-containing compound can be obtained by applying heat on a thin film of silicon-containing compound which is formed by known wet application methods such as spin coat method and dip coat method, or various printing methods.

The sintered body of silicon-containing compound of the present invention can also be obtained by applying heat on a thin film of silicon-containing compound produced by known dry film forming methods such as chemical vapor deposition film forming method (CVD method) using a variety of silane derivatives or alkoxysilane as a raw material.

Producing of the sintered body of silicon-containing compound is carried out at a temperature of preferably not less than 200° C., desirably not less than 300° C., more desirably not less than 400° C. but not more than 1500° C.

The sintered body of silicon-containing compound in solid state obtained in the above-described producing method includes neither a compound capable of dissociating into positive and negative ions nor a liquid electrolyte and a gel electrolyte, and exhibits a dielectric relaxation phenomenon in the frequency range of 100 Hz to 1 MHz.

Herein, according to “New Experimental Chemistry Course 5 (Shin-Jikken Kagaku Kouza 5)” (published by Maruzen, fourth impression, 1987), the dielectric relaxation phenomenon is defined as a phenomenon that the dielectric constant reduces from large values to small values as the frequency is changed from lower frequencies (about 10 Hz) to higher frequencies (10⁸ Hz).

As described above, it is preferred that the sintered body of silicon-containing compound has a Si—OH bond. A Si—OH bond can be confirmed by absorption around 955 cm⁻¹ in the infrared absorption spectrum.

The above-mentioned sintered body of silicon-containing compound in solid state that exhibits the dielectric relaxation phenomenon can be used as a main component of a completely solid type capacitor element, a sensor and an energy converting element.

The completely solid type capacitor element in the present invention comprises a pair of electrodes and at least either one of a silicon-containing compound and a sintered body of silicon-containing compound sandwiched between the pair of electrodes. For the electrodes, metals, metal oxides or conductive organic compounds may be used independently or may be used in the form of a material composed of two or more kinds.

Herein the metals that can be used for the electrodes are: lithium, calcium, magnesium, aluminum, zinc, yttrium, iridium, indium, cadmium, gadolinium, gallium, gold, silver, chrome, silicon, germanium, cobalt, samarium, zirconium, tin, strontium, cesium, cerium, selenium, tungsten, carbon, tantalum, titanium, iron, tellurium, copper, lead, niobium, nickel, platinum, vanadium and palladium. Also metal alloys of two more kinds of the above can be used. As the metal oxides, various oxides of the above metals and metal alloys can be used.

The conductive organic compounds that can be used for the electrodes are: conductive polymers and their derivatives such as polyacetylene, polythiophene, polyparaphenylenevinylene, polypyrrole, polyparaphenylene, polyacene, polythiazyl, polyparaphenylene sulfide, poly(2,5-thienylenevinylene) and polyfluorene, or aromatic amine derivatives and their oligomers. These conductive organic compounds may be used solely or in mixture with a doping agent such as iodine.

Producing of the pair of electrodes formed of a single material or a composite material of two or more kinds of the above metals, metal oxides and conductive organic compounds can be carried out using known wet film forming methods such as spin coat method, dip coat method and screen printing method, or known dry film forming methods such as vapor evaporation method and sputtering method.

An especially preferred material for the electrodes is a chrome compound that is formed of metal chrome by the heat treatment for sintering to produce the sintered body of silicon-containing compound.

The completely solid type capacitor element configured as described above according to the present invention can be charged by application of constant voltage or current between the pair of electrodes, and if a charger is removed after charging and a closed circuit is established via a load, it can act as a power source.

### BRIEF DESCRIPTION OF THE DRAWINGS

FIG. 1 is a graph showing the change in voltage with time of the completely solid type capacitor element produced in Example 1.

FIG. 2 is a graph showing the infrared absorption spectrum of the thin film of the sintered body of silicon-containing compound produced in Example 8.

FIG. 3 is a view showing the relationship between the dielectric constant and the frequency in the thin film of sintered body of silicon-containing compound produced in Example 8.

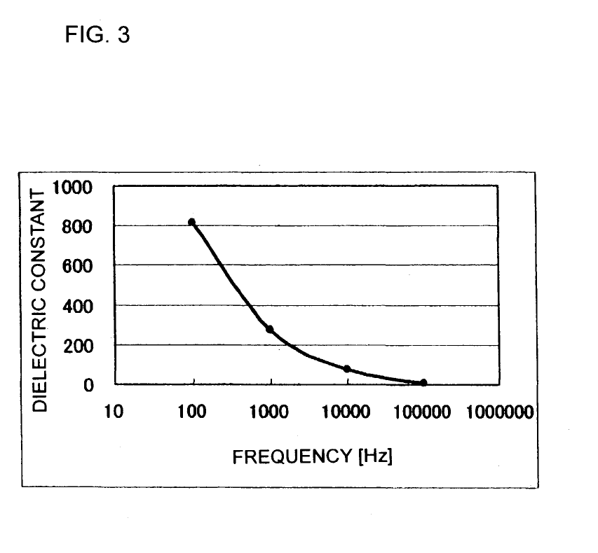

### DESCRIPTION OF THE PREFERRED EXAMPLES

The present invention will now be explained in detail by way of Examples, however, it is to be noted that the present invention is not limited to these Examples.

### EXAMPLE 1

2 parts by weight of polymethylphenylsilane and 1 part by weight of silicone TSR-165 (product of GE TOSHIBA SILICONE) were dissolved in anisole at dark place, to prepare a solution of silicon-containing compound. Chrome was vapor-deposited on one side of a glass substrate of 3 cm square, to prepare a glass substrate equipped with a chrome electrode (20 nm of film thickness). Then the glass substrate equipped with a chrome electrode was coated with a film of the silicon-containing compound solution by spin coating (revolution speed: 2000 rpm), to produce a substrate coated with silicon-containing compound film. After drying, the substrate coated with silicon-containing compound film was sintered at 500° C. for 30 minutes, to obtain a sintered film of silicon-containing compound. On the obtained sintered film of silicon-containing compound, aluminum was vapor-deposited by vapor evaporation, to produce a sandwich type test cell having a structure of chrome/sintered film of silicon-containing compound/aluminum (electrode area: 0.09 cm²) as a completely solid type capacitor element of the present invention.

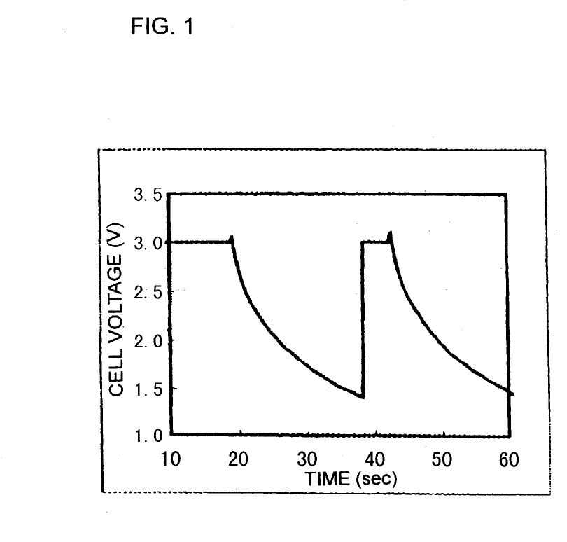

Measurement of dielectric constant and measurement of storage were executed for the test cell as obtained in the above process. Dielectric constant was calculated from capacitance measured by an LCR meter. Storage was measured by discharging the cell at a constant current of 8 mA/cm² until the voltage was 1.4 V after charging the cell by application of a constant voltage of 3V on both electrodes of the cell. This operation was repeated for 50 times. FIG. 1 shows the change in voltage with time during this operation. Table 1 shows the dielectric constants at 100 Hz and 1 MHz, and discharge energies during discharging at first and fiftieth operations.

### EXAMPLE 2

Example 2 was conducted in the same manner as Example 1 except that a solution of silicon-containing compound wherein 2 parts by weight of polymethylphenylsilane, 1 part by weight of silicone TSR-165 (product of GE TOSHIBA SILICONE) and 0.3 part by weight of BTTB (3,3′,4,4′-tetra-(t-butylperoxycarbonyl)benzophenone) [BTTB25 (product of NOF Corporation) was used. Ditto bellow.] were dissolved in anisole at dark place was used. Table 1 also shows the dielectric constants at 100 Hz and 1 MHz, and discharge energies during discharging at first and fiftieth operations in Example 2.

### EXAMPLE 3

Example 3 was conducted in the same manner as Example 1 except that a solution of silicon-containing compound wherein 2 parts by weight of polymethylphenylsilane, silicone TSR-165 (product of GE TOSHIBA SILICONE) and 0.3 part by weight of benzophenone were dissolved in anisole at dark place was used. Table 1 also shows the dielectric constants at 100 Hz and 1 MHz, and discharge energies during discharging at first and fiftieth operations in Example 3.

### EXAMPLE 4

Example 4 was conducted in the same manner as Example 1 except that a solution of silicon-containing compound wherein 2 parts by weight of polymethylphenylsilane was dissolved in anisole at dark place was used, and the obtained substrate coated with silicon-containing compound film was sintered at 750° C. for 30 minutes after drying. Table 1 also shows the dielectric constants at 100 Hz and 1 MHz, and discharge energies during discharging at first and fiftieth operations in Example 4.

### EXAMPLE 5

Example 5 was conducted in the same manner as Example 1 except that a solution of silicon-containing compound wherein 2 parts by weight of silicone TSR-165 (product of GE TOSHIBA SILICONE) was dissolved in anisole at dark place was used, and the obtained substrate coated with silicon-containing compound film was sintered at 750° C. for 30 minutes after drying. Table 1 also shows the dielectric constants at 100 Hz and 1 MHz, and discharge energies during discharging at first and fiftieth operations in Example 5.

### EXAMPLE 6

Example 6 was conducted in the same manner as Example 1 except that a solution of silicon-containing compound wherein 2 parts by weight of polymethylphenylsilane and 0.3 part by weight of BTTB were dissolved in anisole at dark place was used, and the obtained substrate coated with silicon-containing compound film was sintered at 300° C. for 30 minutes after drying. Table 1 also shows the dielectric constants at 100 Hz and 1 MHz, and discharge energies during discharging at first and fiftieth operations in Example 6.

### EXAMPLE 7

Example 7 was conducted in the same manner as Example 1 except that a solution of silicon-containing compound wherein 2 parts by weight of silicone TSR-165 (product of GE TOSHIBA SILICONE) and 0.3 part by weight of benzophenone were dissolved in anisole at dark place was used, and the obtained substrate coated with silicon-containing compound film was sintered at 400° C. for 30 minutes after drying. Table 1 also shows the dielectric constants at 100 Hz and 1 MHz, and discharge energies during discharging at first and fiftieth operations in Example 7.

TABLE 1

| | | | | | Sintering |
|---|---|---|---|---|---|
| | Dielectric | | Discharge Energy | | Tem- |
| | Constant | | 1st Operation | 50th Operation | perature |
| | 100 Hz | 1 MHz | (mWsec/cm²) | (mWsec/cm²) | (° C.) |
| Ex. 1 | 150 | 1.5 | 0.302 | 0.300 | 500 |
| Ex. 2 | 250 | 1.5 | 0.431 | 0.426 | 500 |
| Ex. 3 | 240 | 1.5 | 0.441 | 0.437 | 500 |
| Ex. 4 | 42 | 1.5 | 0.153 | 0.148 | 750 |
| Ex. 5 | 45 | 1.5 | 0.155 | 0.148 | 750 |
| Ex. 6 | 147 | 1.5 | 0.300 | 0.299 | 300 |
| Ex. 7 | 138 | 1.5 | 0.278 | 0.272 | 400 |
| Comp. | 3 | 3.0 | — | — | 150 |
| Ex. 1 | | | | | |

### COMPARATIVE EXAMPLE 1

Comparative example 1 was conducted in the same manner as Example 1 except that the substrate coated with silicon-containing compound film was sintered at 150° C. for 30 minutes after drying. The sintered body of silicon-containing compound obtained in this example did not exhibit the dielectric relaxation phenomenon. Additionally, even when a constant voltage of 3V was applied to both electrodes of the test cell, it did not act as a capacitor element.

### EXAMPLE 8

A solution of silicon-containing compound was prepared by dissolving 2 parts by weight of polymethylphenylsilane, 1 part by weight of silicone TSR-165 (product of GE TOSHIBA SILICONE), 0.3 part by weight of BTTB and about one-hundredth part by weight of surfactant R-08 (product of DAINIPPONINK AND CHEMICALS) in anisole at dark place. This solution of silicon-containing compound was applied on the glass substrate equipped with a chrome electrode produced in the same manner as Example 1 by spin coating (revolution speed: 2000 rpm), to form a thin film of silicon-containing compound.

The above-mentioned thin film of silicon-containing compound was sintered at 550° C. for 30 minutes after drying, to obtain a thin film of sintered body of silicon-containing compound having a film thickness of 0.32 μm.

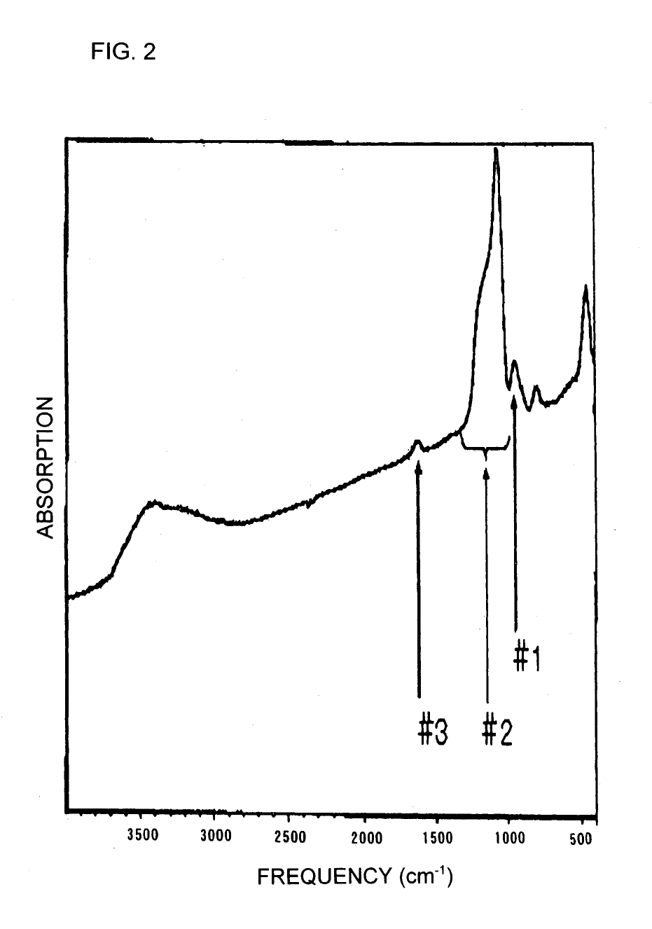

FIG. 2 shows an infrared absorption spectrum of the thin film of sintered body of silicon-containing compound thus obtained. The absorption band #1 observed around 955 cm⁻¹ is absorption based on a Si—OH bond. The absorption band #2 observed around 1000 to 1300 cm is absorption based on a Si—O bond. The absorption band #3 observed around 1650 cm⁻¹ is absorption specific to the present thin film of sintered body of silicon-containing compound.

Next, aluminum was vapor-deposited on the thin film of sintered body of silicon-containing compound thus obtained by vapor evaporation to form an aluminum thin film, whereby a sandwich type test cell (electrode area: 0.09 cm²) having a triple-layered structure of aluminum/thin film of sintered body of silicon-containing compound/chrome was produced.

Capacitances of the test cell thus obtained were measured by means of an LCR meter over the range of 100 to 100 kHz, and dielectric constants were calculated.

FIG. 2 shows the relationship between the dielectric constant and the frequency. As shown in FIG. 2, the dielectric constant is large in the low frequency region and small in the high frequency region, and the dielectric relaxation phenomenon which is peculiar to electrolyte was observed.

In addition, charging/discharging operations as described in Example 1 confirmed that charging and discharging are possible.

### COMPARATIVE EXAMPLE 2

A thin film of sintered body of silicon-containing compound was obtained in the same manner as Example 8 described above except that the thin film of silicon-containing compound was sintered at 300° C. for 30 minutes after drying.

The thin film of sintered body of silicon-containing compound thus obtained was subjected to measurement of infrared absorption spectrum and an infrared absorption spectrum which is different from that of the thin film obtained in Example 8 was observed.

The thin film of sintered body of silicon-containing compound obtained in this example did not exhibit the dielectric relaxation phenomenon, and even when a constant voltage of 3V was applied to both electrodes of the test cell, it did not act as a capacitor element.

As described above, by using the silicon-containing compound or the sintered body of silicon-containing compound according to the present invention, it is possible to produce a completely solid type capacitor element which allows repetitive charging/discharging and has a wide operational temperature range and high reliability. The produced completely solid thin film type capacitor element can be widely used as a thin film light-weight power source or an auxiliary power source, providing excellent industrial utility value.

What is claimed is:

1. A silicon-containing compound of solid state, characterized by including neither a compound capable of dissociating into positive and negative ions nor a liquid electrolyte and a gel electrolyte, and exhibiting a dielectric relaxation phenomenon in the frequency range of 100 Hz to 1 MHz.

2. A sintered body of silicon-containing compound of solid state, characterized by including neither a compound capable of dissociating into positive and negative ions nor a liquid electrolyte and a gel electrolyte, and exhibiting a dielectric relaxation phenomenon in the frequency range of 100 Hz to 1 MHz.

3. The sintered body of silicon-containing compound according to claim 2, wherein the silicon-containing compound contains at least either one of silicon-containing compounds selected from a polysilane which is dissolvable to organic solvents, and a silicone having a chemical structure represented by the following general formula (1): 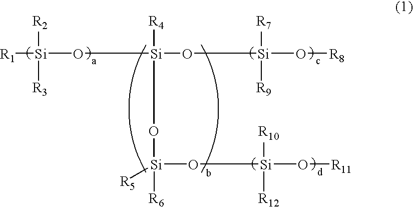
(wherein R₁ to R₁₂ which may be the same or different, represent a group selected from the group consisting of aliphatic hydrocarbon groups having 1 to 10 carbon(s) which may be substituted by a halogen or glycidyloxy group, aromatic hydrocarbon groups having 6 to 12 carbons, and alkoxy groups having 1 to 8 carbon(s); and a, b, c and d each represent an integer including 0 and satisfy the relation a+b+c+d≧1.)

4. The sintered body of silicon-containing compound according to claim 2 or 3, wherein the silicon-containing compound is a mixture containing a silicon compound and at least either one compound of a peroxide and a benzophenone derivative having a benzophenone structure represented by the following formula (2):

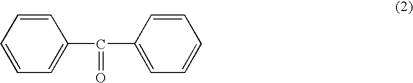

5. The sintered body of silicon-containing compound according to claim 4, wherein the peroxide is a peroxide having at least one bond represented by —C(═O)—O—O— in its molecular structure.

6. The sintered body of silicon-containing compound according to any one of claims 2 to 5, wherein the sintered body of silicon-containing compound has a Si—OH bond.

7. The sintered body of silicon-containing compound according to claim 6 which is obtained by sintering the silicon-containing compound at a temperature of not less than 400° C.

8. A completely solid type capacitor element, characterized by having a structure in which the silicon-containing compound according to claim 1 is sandwiched between a pair of electrodes.

9. A completely solid type capacitor element, characterized by having a structure in which the sintered body of silicon-containing compound according to any one of claims 2 to 7 is sandwiched between a pair of electrodes.

10. The completely solid type capacitor element according to claim 8 or 9, wherein at least one of the pair of electrodes is formed of a chrome compound.

11. The completely solid type capacitor element according to claim 10, wherein the chrome compound is formed of metal chrome by a heat treatment at the time of sintering the silicon-containing compound.

12. The completely solid type capacitor element according to any one of claims 8 to 11, wherein the pair of electrodes, the silicon-containing compound and the sintered body of silicon-containing compound are thin films in shape.

13. A method for producing a sintered body of silicon-containing compound including neither a compound capable of dissociating into positive and negative ions nor a liquid electrolyte and a gel electrolyte, and exhibiting a dielectric relaxation phenomenon in the frequency range of 100 Hz to 1 MHz, wherein the temperature at which the silicon-containing compound is sintered is not less than 200° C.

14. The method for producing a sintered body of silicon-containing compound according to claim 13, wherein the sintering temperature is not less than 400° C.
